(19) United States
(12) Patent Application Publication
(10) Pub. No.: US 2010/0004879 A1
(43) Pub. Date: Jan. 7, 2010

(54) Fluid level measuring system

(76) Inventors: Yingjie Lin, El Paso, TX (US); Carlos A. Urquidi, Cd. Juarez (MX); Jaime N. Salcido, Chihuahua (MX)

Correspondence Address: Delphi Technologies, Inc., M/C 480-410-202, PO BOX 5052, Troy, MI, 48007, US

(21) Appl. No.: 12/217,313

(22) Filed: Jul. 2, 2008

(51) Int. Cl. G01F 23/26

(52) U.S. Cl. 702/55

(57) ABSTRACT

A total capacitance is measured between an inner electrode disposed in a dielectric sleeve and an outer electrode surrounding the sleeve, with a fluid chamber being established between the sleeve and outer electrode. The total capacitance is correlated to a level (l) of fluid in the chamber using an electrode length, a unit length capacitance associated with the sleeve, and a unit length capacitance associated with the fluid chamber when no fluid is in the chamber.

### TECHNICAL FIELD

The present invention relates generally to systems and methods for measuring fluid levels, and more particularly to methods and structure for measuring fluid level in a vehicle engine.

### BACKGROUND OF THE INVENTION

Accurately measuring fluid levels is important in many applications. As but one example, automatically monitoring the quality and amount of oil in a vehicle alerts drivers in a timely fashion when maintenance should be performed as dictated by the actual condition of the vehicle. Other systems such as fuel systems, transmission fluid systems, engine coolant systems, and urea systems (in diesel engines) can pose the need to measure fluid levels.

Capacitive-based level sensors have been introduced but as recognized herein, when the fluid to be measured is characterized by relative high conductance, the conductivity of the fluid dominates total impedance and consequently masks the capacitive contribution of the fluid, even potentially shorting out or shielding the sensing capacitive electrodes.

### SUMMARY OF THE INVENTION

A fluid level sensor includes a first electrode, a second electrode juxtaposed with the first electrode, and a fluid chamber between the electrodes. A total capacitance between the electrodes represents a level of fluid in the chamber.

In some embodiments the electrodes can be elongated. In some embodiments the first electrode can be an inner electrode and the second electrode can be an outer electrode, and the outer electrode can be annular, with the inner electrode being disposed in the outer electrode coaxially therewith. An annular dielectric sleeve may be disposed between the fluid chamber and the outer electrode and may be positioned against an outer surface of the inner electrode. In other embodiments the electrodes can be flat plate-like structures.

A processing system can be electrically connected to both electrodes and can correlate the total capacitance to a fluid level. Furthermore, a display may be connected to the processing system for presenting an audible and/or visual indication of the level.

The processing system can correlate total capacitance to level using the following relationship or mathematical derivation thereof:

total capacitance=[Cₐ*C_{b(air)}*L/(Cₐ+C_{b(air)})]+Cₐ²*l/(Cₐ+C_{b(air}),
wherein L=length of the inner electrode, Cₐ=unit length capacitance taken across the dielectric layer from an outer surface of the dielectric layer to an outer surface of the inner electrode, and C_{b(air)}=unit length capacitance taken from an inner surface of the outer electrode to an outer surface of the dielectric layer when the chamber is completely empty of the fluid.

In another aspect, a method includes establishing a fluid chamber between an inner electrode disposed in a dielectric sleeve and an outer electrode. A total capacitance defined by the electrodes is measured and correlated to a level (l) of fluid in the chamber using an electrode length, a unit length capacitance associated with the sleeve, and a unit length capacitance associated with the fluid chamber when no fluid is in the chamber. A signal can be output for display representing the fluid level.

In another aspect, an apparatus includes an inner elongated capacitive member, an outer elongated capacitive member in which the inner capacitive member is disposed, and a fluid chamber between the capacitive members. A dielectric member is between the fluid chamber and the inner capacitive member. A terminal is on the inner capacitive member and another terminal is on the outer capacitive member. A processor determines a level of fluid in the fluid chamber using a capacitive signal associated with the terminals.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic view of one environment in which the present sensor may be used;

FIG. 2 is a cross-sectional diagram of the structural portions of an example embodiment;

FIG. 3 is an enlarged view of the area indicated by the circle 3-3 in FIG. 2, schematically showing capacitances; and

FIG. 4 is a perspective view of an alternate electrode structure, with portions shown in phantom.

### DESCRIPTION OF AN EMBODIMENT OF THE INVENTION

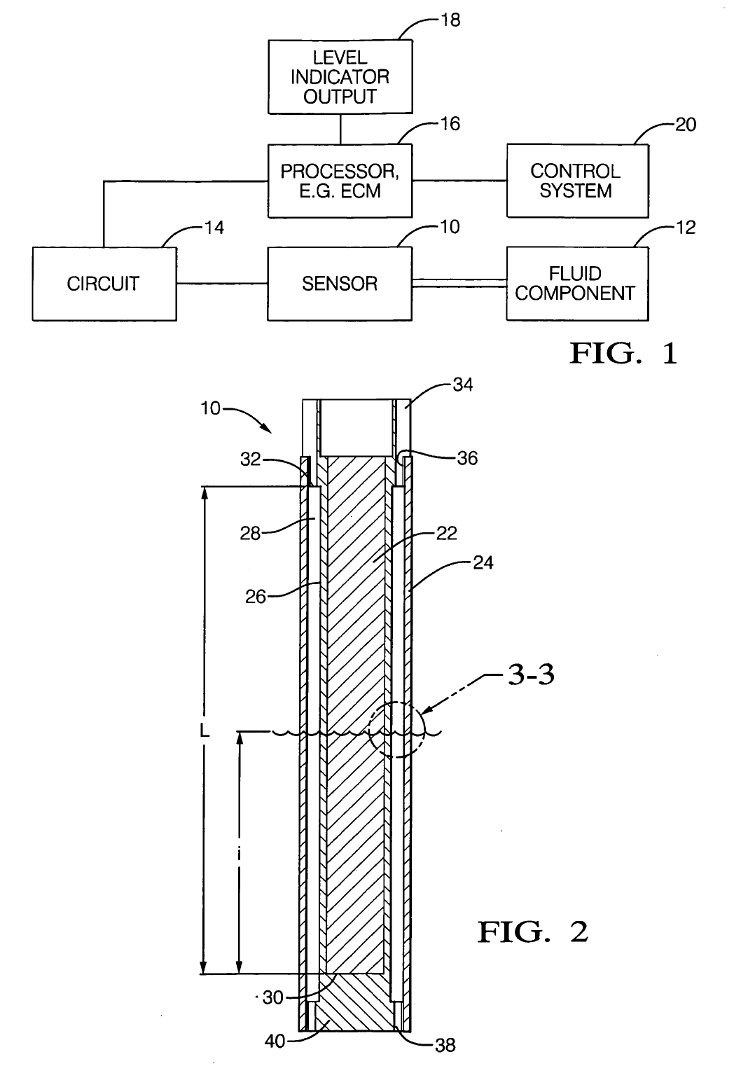

Referring initially to FIG. 1, a sensor 10 is in fluid communication with a fluid system component 12 such as an engine oil reservoir, a fuel tank, a transmission fluid reservoir, a urea reservoir, or other component for which it is desired to measure the level of fluid inside the component. The sensor 10 can be physically disposed in the component 12 so that fluid in the component 12 can flow into the sensor 10 as more fully described below.

The equation below assumes that the sensor 10 is used to measure the level of fluid that has relatively high electrical conductivity, a relatively high dielectric constant, or both, such that the contribution of the impedence of the fluid is negligible compared to the contributions of the impedences of the dielectric and air in the chamber which, when combined with the impedance of the fluid, establish the total capacitance which is measured. Example fluids meeting this criteria include but are not limited to water-based solutions.

In some embodiments the sensor 10 is electrically connected to a circuit 14 and appears as a capacitor in the circuit 14. In turn, the circuit 14 is connected to a processor 16 such as an engine control module (ECM) that correlates a capacitance associated with the sensor 10 to a fluid level in the sensor 10 and, thus, to a fluid level in the component 12. The processor 16 can output an audible and/or visual indication of the fluid level on a display 18 and may also generate control signals to a control system 20 based on the fluid level in the component 12.

Details of an embodiment of the sensor 10 may be seen in FIG. 2. An inner electrode 22, which may be elongated, is disposed in an annular outer electrode 24, which may also be elongated, it being understood that while the space between the electrodes 22, 24 shown in FIG. 2 is thus cylindrical, it may have other than cylindrical shapes in radial cross-section.

A dielectric sleeve 26 closely surrounds the inner electrode 22 and may be in contact against the outer surface of the inner electrode 22. An annular elongated fluid chamber 28 is established between the dielectric sleeve 26 and outer electrode 24 as shown, and the inner electrode 22 defines a length “L” from the bottom 30 of the inner electrode 22 to the top 32 of the fluid chamber 28. As shown, the electrodes 22, 24, sleeve 26, and fluid chamber 28 may all be coaxial with each other.

The top of the sensor 10 may be at least partially enclosed by a top cover 34 that may be formed with vents 36 to permit fluid to enter into the fluid chamber 28 through bottom channels 38 that lead to the fluid chamber 28 and that may be formed between the outer electrode 24 and a solid bottom portion 40 of the sleeve 26. With this structure, fluid may flow into the fluid chamber 28 to an arbitrary level “l”. As set forth further below, the capacitance defined by the electrodes 22, 24 may be correlated to the fluid level “l”.

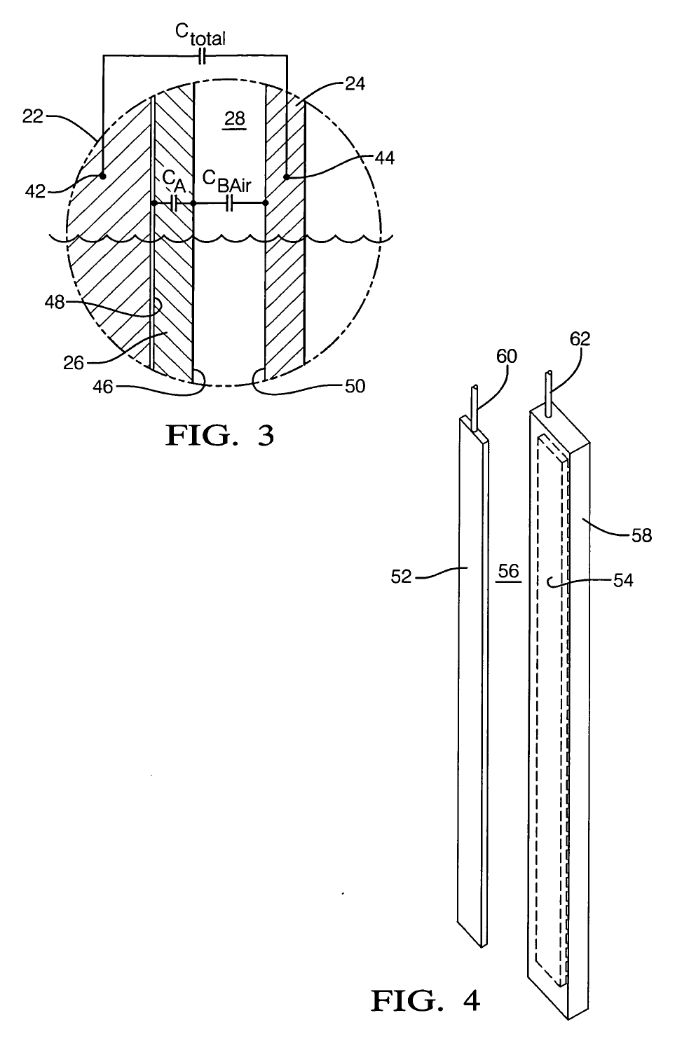

FIG. 3 illustrates the sensor 10 in greater detail and schematically shows capacitance values that may be used in accordance with present principles. As shown, respective terminals 42, 44 are established on the inner and outer electrodes 22, 24, and a total capacitance (“Cₜₒₜₐₗ” in FIG. 3) may be measured between the terminals 42, 44. It is to be understood that the terminals 42, 44 may be connected to the circuit 14 shown in FIG. 1 so that the processor 16 may receive a signal representative of the total capacitance.

Two constant unit length capacitances are also shown schematically in FIG. 3. With more specificity, a capacitance Cₐ is shown that is a unit length capacitance taken across the dielectric sleeve 26 from an outer surface 46 of the dielectric sleeve 26 to an outer surface 48 of the inner electrode 22. Also, a capacitance C_{b(air)} is shown that is a unit length capacitance taken from an inner surface 50 of the outer electrode 24 to the outer surface 46 of the dielectric sleeve 26 when the fluid chamber 28 is empty of the fluid.

With this in mind, the processor 16 may correlate total capacitance to level using the following relationship or mathematical derivation thereof:

total capacitance=[Cₐ*C_{b(air)}*L/(Cₐ+C_{b(air)})]+Cₐ²*l/(Cₐ+C_{b(air)}.

As recognized herein, Cₐ is a fixed number that is determined by the geometry of the sensor 10 and the dielectric constant of the sleeve 26, while C_{b(air)} is also a fixed number that is determined by the geometry of the sensor 10.

FIG. 4 shows that instead of concentric electrodes, first and second flat, straight, plate-like electrodes 52, 54 can be juxtaposed with each other and may be parallel to each other to define a fluid chamber 56 therebetween. A dielectric material 58 may cover the second electrode 54 as shown. Respective terminals 60, 62 may be connected to the electrodes 52, 54 for measuring the total capacitance therebetween.

While the particular FLUID LEVEL MEASURING SYSTEM is herein shown and described in detail, it is to be understood that the invention is limited only by the appended claims.

What is claimed is:

1. A fluid level sensor, comprising:
a first electrode;
a second electrode juxtaposed with the first electrode; and
a fluid chamber between the electrodes, wherein a total capacitance between the electrodes represents a level of fluid in the chamber.

2. The sensor of claim 1, wherein the electrodes are elongated.

3. The sensor of claim 1, wherein the second electrode is annular and the first electrode is disposed in the second electrode coaxially therewith.

4. The sensor of claim 3, further comprising an annular dielectric sleeve disposed between the fluid chamber and the second electrode.

5. The sensor of claim 4, wherein the sleeve is positioned against an outer surface of the first electrode.

6. The sensor of claim 1, further comprising a processing system electrically connected to both electrodes and correlating the total capacitance to a fluid level.

7. The sensor of claim 6, comprising a display connected to the processing system and presenting an audible and/or visual indication of the level.

8. The sensor of claim 6, further comprising a dielectric layer disposed between the fluid chamber and the second electrode, wherein the processing system correlates total capacitance to level using the following relationship or mathematical derivation thereof:
total capacitance=[Cₐ*C_{b(air)}*L/(Cₐ+C_{b(air)})]+Cₐ²*l/(Cₐ+C_{b(air)}, wherein L=length of the first electrode to a top of the fluid chamber, Cₐ=unit length capacitance taken across the dielectric layer from an outer surface of the dielectric layer to an outer surface of the first electrode, and C_{b(air)}=unit length capacitance taken from an inner surface of the second electrode to an outer surface of the dielectric layer when the chamber is completely empty of the fluid.

9. The sensor of claim 1, wherein the second electrode is substantially straight and flat and the first electrode is substantially straight and flat.

10. A method comprising:
establishing a fluid chamber between an inner electrode disposed in a dielectric sleeve and an outer electrode;
measuring a total capacitance defined by the electrodes;
correlating the total capacitance to a level (l) of fluid in the chamber using an electrode length, a unit length capacitance associated with the sleeve, and a unit length capacitance associated with the fluid chamber when no fluid is in the chamber; and
outputting a signal for display representing the fluid level.

11. The method of claim 10, wherein the correlating act is executed at least in part using the following relationship or mathematical derivation thereof:
total capacitance=[Cₐ*C_{b(air)}*L/(Cₐ+C_{b(air)})]+Cₐ²*l/(Cₐ+C_{b(air)}, wherein L=length of the inner electrode to a top of the fluid chamber, Cₐ=unit length capacitance taken across the dielectric layer from an outer surface of the dielectric layer to an outer surface of the inner electrode, and C_{b(air)}=unit length capacitance taken from an inner surface of the outer electrode to an outer surface of the dielectric layer when the chamber is completely empty of the fluid.

12. The method of claim 10, wherein the electrodes are elongated.

13. The method of claim 10, wherein the outer electrode is annular and the inner electrode is disposed in the outer electrode coaxially therewith.

14. The method of claim 13, wherein the dielectric sleeve is annular and is disposed between the fluid chamber and the outer electrode.

15. The method of claim 10, further comprising displaying the fluid level.

16. Apparatus, comprising:
an inner elongated capacitive member;
an outer elongated capacitive member, the inner capacitive member being disposed in the outer capacitive member;
a fluid chamber between the capacitive members;
a dielectric member between the fluid chamber and the inner capacitive member;
a terminal on the inner capacitive member;
a terminal on the outer capacitive member; and
a processor determining a level of fluid in the fluid chamber using a capacitive signal associated with the terminals.

17. The apparatus of claim 16, comprising a display connected to the processor and presenting an audible and/or visual indication of the level.

18. The apparatus of claim 16, wherein the processor correlates the capacitive signal to the level (l) using a capacitive member length, a unit length capacitance associated with the dielectric member, and a unit length capacitance associated with the fluid chamber when no fluid is in the chamber.

19. The apparatus of claim 18, wherein the processor correlates the capacitive signal to level using the following relationship or mathematical derivation thereof:
capacitive signal=[Cₐ*C_{b(air)}*L/(Cₐ+C_{b(air)})]+Cₐ²*l/(Cₐ+C_{b(air)}, wherein L=length of the inner elongated capacitive member to a top of the fluid chamber, Cₐ=unit length capacitance taken across the dielectric member from an outer surface of the dielectric member to an outer surface of the inner elongated capacitive member, and C_{b(air)}=unit length capacitance taken from an inner surface of the outer elongated capacitive member to an outer surface of the dielectric member when the chamber is completely empty of the fluid.
